(19) United States
(12) Patent Application Publication
(10) Pub. No.: US 2004/0095598 A1
(43) Pub. Date: May 20, 2004

(54) Method of communicating with a proprietary printing system over a communications network

(75) Inventor: Timothy B. Snell, Rochester, NY (US)

Correspondence Address: BRINKS HOFER GILSON & LIONE, P.O. Box 10395, Chicago, IL, 60610-0395, US

(73) Assignee: Heidelberg Digital, L.L.C.

(21) Appl. No.: 10/299,176

(22) Filed: Nov. 19, 2002

(51) Int. Cl. G06F 17/30; G06F 15/00

(52) U.S. Cl. 358/1.15; 707/104.1

(57) ABSTRACT

A proprietary printing system communicates over a communications network in a standard data format, such as SNMP. The proprietary printing system includes a database, such as a SQL database, that represents the MIB tables for the SNMP interface. The database translates information from a proprietary data format into the standard data format and places the information in the MIB tables.

### FIELD OF THE INVENTION

This invention relates to network printing. More particularly the invention relates to a method of communicating with a proprietary printing system over a communications network.

### BACKGROUND

A digital printing system may provide for remote operation of the printing system from a remote processing system. Running a print job on the printing system or configuring the printing system remotely requires that the remote processing system communicate with the printing system. Typically, the remote processing system communicates with the printer system over a communications network, such as a local area network (“LAN”) or the Internet.

Standard protocols for communicating with printing systems over the network include the Simple Network Management Protocol (“SNMP”), the Internet Printing Protocol (“IPP”), and the eXtensible Markup Language (“XML”) among others. For example, the remote processing system may construct a request according to the standard protocol and transmit a message containing the request over the communications network to the printing system. The printing system receives the request, and it retrieves the requested information from its memory or initiates a routine to collect the requested information. The requested information may include job status, available finishing devices, paper catalog list, or job capacity on the printing system. Upon gathering the requested information, the printing system constructs a response that includes the requested information according to the standard protocol, and it transmits another message containing the response over the communications network to the remote processing system.

Some proprietary printing systems, however, are not configured to communicate according to standard protocols because they are highly specialized. For example, digital printing systems may include a computer server, or controller, and one or more printing machines. The controller receives, stores, and processes print jobs that have been submitted to the printing system. The controller also is the sole component of the proprietary printing system that is connected to the communications network. The controller also allocates each print job to the appropriate printing machine for processing and finishing. Due to the complexity of the printing system, the controller typically communicates with the printing machines using a proprietary protocol.

The proprietary printing system is capable of performing complex and specialized printing tasks, and so the proprietary protocol is designed to provide full control of and access to the printing machines. In contrast, the standard protocols are designed to provide access to a general set of tasks that are common to a wide variety of non-specialized printing devices. Therefore, messages including proprietary protocol commands are not usable across the communications network.

### SUMMARY

A method is described below to address the need for communicating with a proprietary printing system over a communications network using a standard protocol.

In order to address the deficiencies in the prior art, a method for communicating with a proprietary printing system over a communications network includes updating at least one printer table in a database with first data from a proprietary printing device in the proprietary printing system. The first data is in a proprietary data format. The method also includes converting the first data to second data within the database. The second data is in a standard data format. The method further includes writing the second data to at least one message table in the relational database.

The foregoing and other features and advantages of preferred embodiments of the present invention will be more readily apparent from the following detailed description, which proceeds with reference to the accompanying drawings.

### BRIEF DESCRIPTION OF THE DRAWINGS

FIG. 1 is a block diagram illustrating an embodiment of a network printing system;

FIG. 2 is a block diagram illustrating a database structure for communicating with the proprietary printing system of FIG. 1;

FIG. 3 is a flow diagram illustrating a method of communicating with a proprietary printing system of FIG. 1 over a communications network;

FIG. 4 is a flow diagram illustrating a method of responding to a query message from the communications network of FIG. 1; and

FIG. 5 is a flow diagram illustrating a method of transmitting an alert message to the communications network of FIG. 1.

### DETAILED DESCRIPTION OF THE PRESENTLY PREFERRED EMBODIMENTS

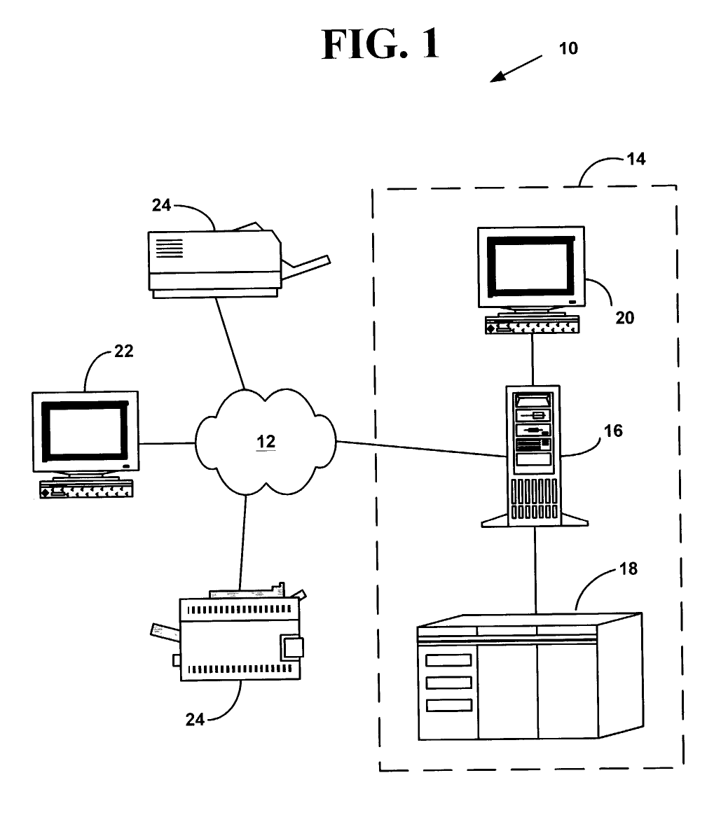

FIG. 1 is a block diagram illustrating one embodiment of a network printing system 10. A communications network 12 permits the communication between the components of the system 10 according to a network protocol. For example, the communications network 12 may be the Internet and communication is according to the Internet Protocol (“IP”). The Internet Protocol is described in the Internet Engineering Task Force (“IETF”) standard Request For Comments (“RFC”) 791—Internet Protocol, dated September 1981. Alternatively, the communications network 12 is a LAN and communication over the LAN may be according to a variety of protocol suites known to those skilled in the art, including IP.

A proprietary printing system 14 is connected to the communications network 12. Typically, the proprietary printing system 14 includes a processing system 16, a proprietary printing device 18, and an operator console 20. Through the operator console 20, a printer operator may program the proprietary printing system 14 to run or stop a print job, select media for the print job, and select a finishing device attached to the proprietary printing device 18, among other operations. The network printing system 10 may also include a remote processing station 22 for remotely programming the proprietary printing system 14 across the communications network 12.

In one embodiment, the processing system 16 is a network device, such as a server, that is distinct from the proprietary printing device 18. It should be understood, however, that the processing system 16 may be integrated into the proprietary printing device 18 and that the present invention is not limited to the arrangement of network devices depicted in FIG. 1.

The processing system 16 controls many or all aspects of printing one or more print jobs on the proprietary printing device 18. The processing system 16 may be physically implemented using one or more data processors, in a conventional or parallel computing architecture to control the printing process. The processing system 16 may determine a pattern of media feeds for each output set of a print job to achieve a desired appearance characteristic of sheets of an output set. The desired appearance characteristic may include scaling of an image, resolution of an image, contrast of an image, darkness or intensity of an image, the order of sheets in an output set, the selection of media for different sheets in an output set, stapling of sheets in an output set, binding of an output set, holes in media of the output set, or other attributes that affect the visual appearance or presentation of a print job.

The proprietary printing system 14 may maintain data bits at memory locations in its respective memory systems to reconfigure or otherwise alter the operation of the server, as well as other processing of signals. The memory locations, such as random access memory (“RAM”), are physical locations that have particular electrical, magnetic, or optical properties corresponding to the data bits, depending on the type of memory used. The data bits may also be maintained on a computer readable medium including magnetic disks, optical disks, and any other volatile or non-volatile mass storage system readable by the processing system 16 of the proprietary printing system 14. The computer readable medium includes cooperating or interconnected computer readable media that exist exclusively on the proprietary printing system 14 or are distributed among multiple interconnected processing systems, such as among the remote processing station 22 and the proprietary printing system 14.

The network printing system 10 may also include other network devices, such as printing devices 24, which communicate over the communications network 12 according to a standardized data format now known or later developed. An exemplary standardized format is the Internet Printing Protocol (“IPP”). IPP is described in the IETF standard RFC 2567 titled “Design Goals for an Internet Printing Protocol,” dated April 1999. Another exemplary standardized format for communicating with network devices over the communications network 12 is the Extensible Markup Language. XML is described in the World Wide Web Consortium (“W3C”) recommendation titled “Extensible Markup Language (XML) 1.0 (Second Edition),” dated October 2000.

A further exemplary standardized format for communicating with network devices over the communications network 12 is the Simple Network Management Protocol (“SNMP”). SNMP is described in the IETF standard RFC 1157 titled “A Simple Network Management Protocol (SNMP),” dated May 1990, in combination with Management Information Bases (“MIBs”). The MIBs are described in IETF standards RFC 1759 titled “Printer MIB,” dated March 1995, RFC 2790 titled “Host Resources MIB,” dated March 2000, and RFC 2707 titled “Job Monitoring MIB—V1.0,” dated November 1999. A further MIB is described in IETF Internet Draft titled “Printer Finishing MIB,” dated October 2002. The printing device 24 information is stored in a MIB. The MIB defines which attributes of the printing device 24 may be reported in response to SNMP queries, what status information on the printing device 24 is available to other network devices, and the forms of alert messages from the printing device 24.

In the case of printing devices 24, these standardized formats permit other network devices, such as the remote processing station 22, to query the printing devices 24 over the communications network 12. A query of a printing device 24 may request information regarding the status of the printing device 24. The information may include the status of a print job, the status of the printing device 24, the identities of which finishing devices are attached to the printing device 24 and are available for use, the buffer size of the printing device 24, a paper catalog list of the media available to the printing device 24 or presently loaded in the paper sources of the printing device 24, or job capacity information such as how many print jobs are in the queue of the printing device 24. Further, the printing device 24 may alert the remote processing station 22 through an SNMP message should a definable condition occur on the printing device 24, e.g., the printing device 24 is out of paper or is off-line.

The components of the proprietary printing system 14, however, communicate according to a proprietary data format, i.e., a non-standardized data format. Typically, the proprietary printing device 18 communicates with the processing system 16 over a parallel connection, a serial connection, a Universal Serial Bus (“USB”) connection, a Small Computer System Interface (“SCSI”) connection, or other connection permitting the transfer of the proprietary data format. Because the proprietary printing device 18 does not communicate according to the standardized format, the other network devices on the communications network 12 are unable to retrieve or receive information directly from the proprietary printing device 18.

An SNMP agent program, however, may be installed on the processing system 16. The SNMP agent receives SNMP messages from the communications network 12 and transmits SNMP messages to the communications network 12. The SNMP agent also implements at least one MIB, retained as a tree structure database in memory in the processing system 16 or elsewhere, to recognize and construct SNMP messages.

In one embodiment of the present invention, the at least one MIB is represented as a Structured Query Language (“SQL”) database. SQL is a query language for defining and maintaining information in a relational, or tree structure, database. SQL is described in the American National Standards Institute (“ANSI”) standards ISO/IEC 9075-1:1999 through ISO/IEC 9075-5:1999. As is known to those of skill in the art, when a SQL database is updated, for example by writing data to the database, the database may fire a “database trigger.” In response to the database trigger, the processing system 16 executes a “database stored procedure” that is associated with the database trigger.

Translating Proprietary Data to a Standardized Data Format

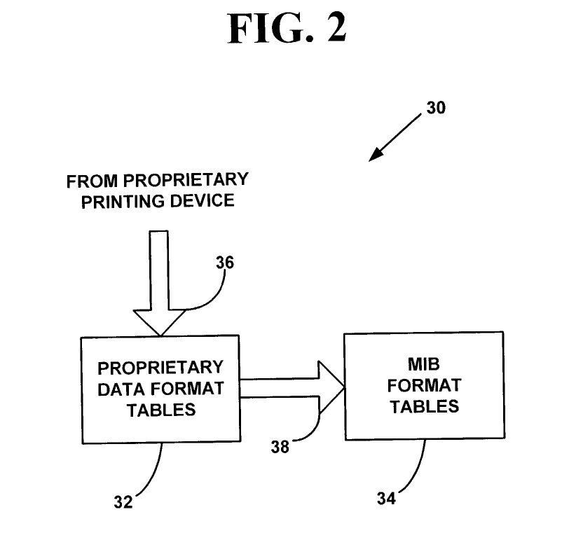

FIG. 2 is a block diagram illustrating a database structure 30 for communicating with a proprietary printing system 14. The database structure 30 includes two sets of tables 32-34, such as SQL tables in a SQL database. A first set of tables 32 includes entries corresponding to the proprietary data format. A second set of tables 34 includes entries corresponding to the standardized data format, such as the entries in the MIB tables.

In response to a change in the proprietary printing device 18, the processing system 16 writes data 36 in the proprietary data format to an entry or entries in the proprietary data format, or printer, tables 32. The data in the proprietary data format corresponds to the change on the proprietary printing device 18. The writing of data to the proprietary data format tables 32 fires a database trigger of the database structure 30. In response to the database trigger, the processing system 16 executes a “database stored procedure” 38. The database stored procedure 38 reads the updated proprietary data from the updated entry or entries in the proprietary data format tables 32, translates the data from the proprietary data format to the standardized data format, and writes the data in the standardized data format to an entry or entries in the MIB format, or message, tables 34. In response to a SNMP request message that is received by the proprietary printing system 14 from the communications network 12, the SNMP agent on the processing system 16 reads the data from the entry in the MIB format tables 34.

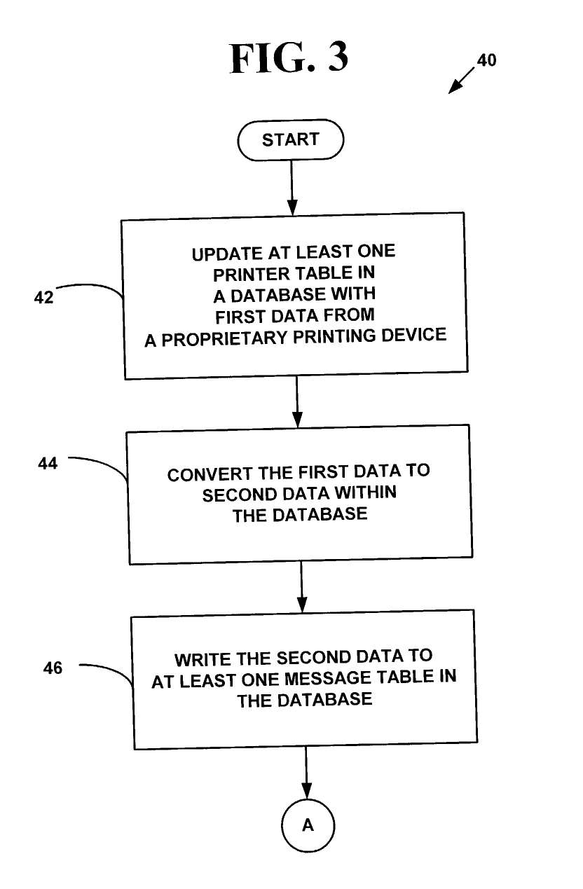

FIG. 3 is a flow diagram 40 illustrating a method of communicating with the proprietary printing system 14 of FIG. 1 over the communications network 12. The method 40 includes updating at least one printer table 32 in a database with first data from a proprietary printing device 18 in the proprietary printing system 14 at step 42. The first data is in a proprietary data format. At step 44, the processing system 16 converts the first data to second data within the database. The second data is in a standard data format. The processing system 16 writes the second data to at least one message table 34 in the database at step 46.

In one embodiment, the proprietary printing device 18 communicates first data, such as status and configuration data, in a proprietary data format to the processing system 16. The proprietary printing device 18 may signal a change in the status or configuration, which is detected by the processing system 16. The change may be detected within the proprietary printing device 18 and signaled to the processing system 16 via a parallel, serial, USB, SCSI or other connection. Alternatively, the processing system 16 may repetitively prompt the proprietary printing device 18 to report any change.

The processing system 16 reads the first data and updates at least one table containing information in the proprietary data format. In one embodiment, the at least one printer table 32 is a first set of tables in a SQL database, wherein each entry in the first set of tables is in the proprietary data format. For example, the proprietary printing device 18 might supply a ready/not ready status signal as a two byte id/value pair. The id/value pair may have the proprietary data format: byte 1, id=05 (general printer state); byte 2, value=00 (ready) or 01 (not ready). One of the printer tables 32 in the SQL data base may be named General_Printer_State and contain a single column, named State and defined as an integer, which represents the first data stored in the table 32 in proprietary data format. A correspondence between the ready/not ready status signal from the proprietary printing device 18 and the entry in the SQL table is shown in Table 1:

TABLE 1

| | |
|---|---|
| Proprietary Data Format -- | SQL Database Table with |
| General Printer State | Proprietary Data Format -- |
| id/value pair | General_Printer_State |

| Id | Value | State |
|---|---|---|
| 05 | 00 -- Ready | 00 -- Ready |
| | 01 -- Not Ready | 01 -- Not Ready |

Also, when the proprietary printing system 14 or its components start up, the proprietary printing device 18 communicates data representing its status and configuration to populate the printer tables 32. If the printer tables 32 are initially empty, the population of the printer tables 32 corresponds to creating each entry in the printer tables 32. The processing system 16 interprets the creation of an entry as an update, albeit from a null entry. Alternatively, the processing system 16 may retain in memory a copy of prior printer tables 32. In this case, each entry in the printer tables 32 is updated according to data received from the priority printing device 18 upon startup.

In response to each update on the printer tables 32, the processing system 16 fires a database trigger. The database trigger in turn calls a database stored procedure 38. In the example above, the SQL database is set up to define a “fire on update” or similar relationship between the General_Printer_State table and the database trigger for example called “General_Printer_State_Change_Trigger.” In this manner, when the General_Printer_State table is updated, the SQL database will “fire” the “General_Printer_State_Change_Trigger”. In response to the named database trigger, the processing system 16 executes the database stored procedure 38 that translates the first data from the proprietary data format into the standardized format.

The database stored procedures 38 may be written according to a variety of programming languages. Examples of programming languages are the “C++” programming language and the Practical Extraction and Reporting Language (“Perl”). Information on C++ may be found in the American National Standards Institute (“ANSI”) standard ISO/IEC 14882, titled “Programming languages—C++,” dated 1998, and information on Perl may be found at the Perl webpage. Perl home page [online].

The database stored procedure 38 reads the updated data in the printer tables 32, translates the data into the standard data format, and updates the at least one message table, which includes entries in the standard data format. In the example above, the database stored procedure 38 reads the updated data in the General_Printer_State database table 32 of Table 1. The processing system 16 translates the state value of “00” or “01” and updates another table in the SQL database called “Standard_Printer_Status.” In one embodiment, this table has two columns, both strings: Printer Name and Printer Readiness. The database stored procedure 38 translates a “State” value of 00 to the “Printer Readiness” string value “Printer is Ready.” Similarly, the database stored procedure 38 translates a “State” value of 01 to the “Printer Readiness” string value “Printer is NOT Ready.” A correspondence between the entry in the first SQL table 32 and the entries in the second SQL table 34 is shown in Table 2:

TABLE 2

| SQL Database Table with | | |
|---|---|---|
| Proprietary Data Format -- | SQL Database Table with Standard Data | |
| General_Printer_State | Format -- Standard_Printer_Status | |
| State | Printer Name | Printer Readiness |
| 00 -- Ready | “My Printer” | “Printer is Ready” |
| 01 -- Not Ready | | “Printer is NOT Ready” |

One advantage of the above method is that the proprietary printing device 18 need not be altered or reconfigured to accommodate data conversion to the standard data format. As such, any change in performance of the proprietary printing device 18 is minimal. Another advantage is that the processing system 16 merely supports a database, such as a SQL database. A further advantage is that to fulfill the SNMP requests, the SNMP agent reads information from the database tables and does not query the proprietary printing device 18.

SNMP Response and Alert Messages

To respond to SNMP queries, the SNMP agent on the processing system 16 reads the MIB data from table Standard_Printer_Status, the second SQL table 34. The SNMP agent constructs an SNMP response message that includes the MIB data from the second SQL table 34. Similarly, to issue a SNMP alert message (also called an “SNMP Trap”), such as in response to a printer jam, the processing system 16 uses a “listen” function of the SQL database, known to those of skill in the art, to determine when an entry in the second SQL table 34 updates. In response, the SNMP agent constructs the SNMP alert message and incorporates the MIB data from the entry into the SNMP alert message.

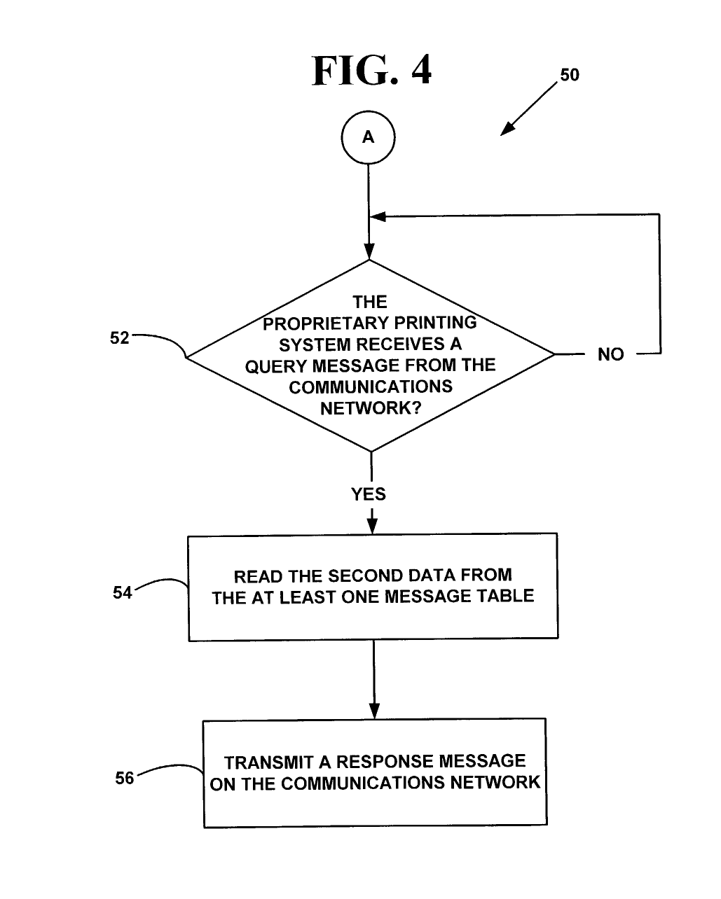

FIG. 4 is a flow diagram illustrating a method 50 of responding to a query message, such as a SNMP query message, from the communications network 12 of FIG. 1. The method includes determining whether the proprietary printing system 14 received a query message from the communications network 12 at step 52. At step 54, the processing system 16 reads the second data from the at least one message table 34 when the proprietary printing system 14 receives the query message from the communications network 12. Further, at step 56, the processing system 16 transmits a response message on the communications network 12. The response message includes the second data.

In one embodiment, the processing system 16 receives a SNMP query message from the communications network 12. In the example above, the SNMP query requests the state of the printer “My Printer.” The processing system 16 accesses the second set of tables 34 in the SQL database for the Standard_Printer_Status table as shown in Table 2. The processing system 16 reads the character string in the table entry corresponding to My Printer, “Printer is Ready” for example. The table entry is in the format for a MIB table entry. The processing system 16 creates a SNMP response message and inserts the character string in the response message. Upon creating the SNMP response message, the processing system 16 transmits the SNMP response message on the communications network 12, such as within an IP packet as is known to those of skill in the art.

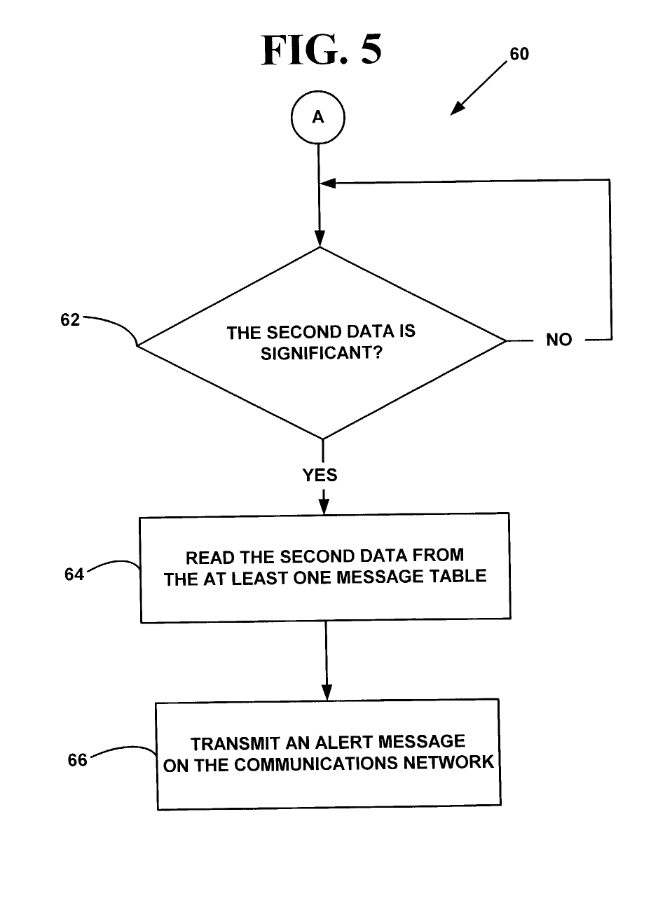

The proprietary printing system 14 may also transmit SNMP alert messages, for example a notification to other network devices and remote processing stations 22 that a paper jam or other asynchronous event has occurred on the proprietary printing device 18. FIG. 5 is a flow diagram illustrating a method 60 of transmitting an alert message, such as a SNMP alert message, to the communications network 12 of FIG. 1. The method 60 includes determining whether the second data is significant at step 62. If the second data is significant, the processing system 16 reads the second data from the at least one message table 34 at step 64. At step 66, the processing system 16 transmits an alert message on the communications network 12. The alert message includes the second data.

In one embodiment, the processing system 16 reacts immediately to a significant MIB table 34 update. A significant update is an update that requires that an alert be broadcast to other network devices, such as the remote processing system 22, to notify the other network devices of a significant event on the proprietary printing device 18. For example, a significant event may be a paper jam on the proprietary printing device 18 that requires alerting the printer operator and other users of the proprietary printing system 14 that intervention is required to clear the paper jam and restore the proprietary printing device 18 to operation. Another significant event may be that the proprietary printing device 18 is out of printing media and requires that the printer operator load new media.

The processing system 16 is programmed to detect a significant event. The relational database language includes a “listen” command that detects when a particular table entry is updated. For example, a table 34, such as a table named “Standard_Printer_Error” and formatted similarly to a MIB table, may include character strings such as “Paper Jam” or “Media Tray Empty” to indicate errors that require the intervention of the printer operator. The processing system monitors the Standard_Printer_Error table 34 for any update. On detecting an update, such as the character string “Paper Jam,” the processing system 16 accesses the second set of tables 34 in the SQL database for the Standard_Printer_Error table. The processing system 16 reads the character string in the table entry, “Printer Jam” for example. The table entry is in the format for a MIB table entry. The processing system 16 creates a SNMP alert message and inserts the character string in the alert message. Upon creating the SNMP alert message, the processing system 16 transmits the SNMP alert message on the communications network 12, such as within an IP packet as is known to those of skill in the art. In an alternative embodiment, the alert messages are XML messages.

It should be understood, however, that the SNMP interface and SQL database are for exemplary purposes only and that the present invention is not limited to this data format and type of database. For example, the interface may be a XML or IPP interface, both of which retain database tables whose entries are defined by the database system, such as character strings, numeric, or Boolean data types. Also, as may be appreciated by one of skill in the art, the database is not restricted to a SQL database, and that other database types and language may be used, such as other relational databases and object oriented databases. For example, a XML interface may retain database tables that support data in the Job Document Format (“JDF”).

The foregoing detailed description is merely illustrative of several embodiments of the invention. Variations of the described embodiments may be encompassed within the purview of the claims. The steps of the flow diagrams may be taken in sequences other than those described. Accordingly, any description of the embodiments in the specification should be used for general guidance, rather than to restrict any broader descriptions of the elements in the following claims.

We claim:

1. A method of communicating with a proprietary printing system over a communications network, comprising:
(a) updating at least one printer table in a database with first data from a proprietary printing device in the proprietary printing system, wherein the first data is in a proprietary data format;
(b) converting the first data to second data within the database, wherein the second data is in a standard data format; and
(c) writing the second data to at least one message table in the database.

2. A computer readable medium, having stored therein instructions for causing a central processing unit to execute the method of claim 1.

3. The method of claim 1 wherein step (b) comprises:
(b1) firing a trigger of the database in response to step (a); and
(b2) translating the first data to the second data in response to the trigger.

4. The method of claim 3 wherein step (b2) comprises:
(b3) executing a database stored procedure of the database that translates the first data to the second data.

5. The method of claim 1 wherein step (a) comprises:
(a1) reading the first data from the proprietary printing device; and
(a2) writing the first data to an entry in the at least one printer table.

6. The method of claim 5 further comprising:
(a3) detecting a change in the proprietary printing device, whereby the change initiates step (a1).

7. The method of claim 1 wherein the database is a relational database.

8. The method of claim 7 wherein the relational database is a Structured Query Language database.

9. The method of claim 1 wherein the database is an object oriented database.

10. The method of claim 1 further comprising:
(d) determining whether the proprietary printing system receives a query message from the communications network;
(e) reading the second data from the at least one message table when the proprietary printing system receives the query message from the communications network; and
(f) transmitting a response message on the communications network, wherein the response message includes the second data.

11. The method of claim 1 further comprising:
(d) determining whether the second data is significant;
(e) reading the second data from the at least one message table when the second data is significant; and
(f) transmitting an alert message on the communications network, wherein the alert message includes the second data.

12. A method of communicating with a proprietary printing system over a communications network, comprising:
(a) reading first data from a proprietary printing device in the proprietary printing system, wherein the first data is in a proprietary data format;
(b) writing the first data to an entry in at least one printer table in a relational database;
(c) firing a trigger of the relational database;
(d) executing a database stored procedure of the relational database that translates the first data to second data, wherein the second data is in a standard data format; and
(e) writing the second data to at least one message table in the relational database.

13. A computer readable medium, having stored therein instructions for causing a central processing unit to execute the method of claim 12.
